(19) United States
(12) Patent Application Publication
(10) Pub. No.: US 2008/0191975 A1
(43) Pub. Date: Aug. 14, 2008

(54) PLASMA DISPLAY PANEL

(76) Inventor: Chong-Gi Hong, Suwon-si (KR)

Correspondence Address: CHRISTIE, PARKER & HALE, LLP, PO BOX 7068, PASADENA, CA, 91109-7068, US

(21) Appl. No.: 12/027,212

(22) Filed: Feb. 6, 2008

(30) Foreign Application Priority Data
Feb. 8, 2007 (KR) 10-2007-0013310

(51) Int. Cl. G09G 3/28

(52) U.S. Cl. 345/72

(57) ABSTRACT

A plasma display panel for displaying an image at its front surface by employing gas excitation, the plasma display panel including a plurality of discharge cells for displaying the image, wherein phosphors colored with a first color are coated in the discharge cells, and at least one layer having a second color, wherein the first and second colors are complementary.

### CROSS-REFERENCE TO RELATED PATENT APPLICATION

This application claims priority to and the benefit of Korean Patent Application No. 10-2007-0013310, filed on Feb. 8, 2007, in the Korean Intellectual Property Office, the entire content of which is incorporated herein by reference.

### BACKGROUND OF THE INVENTION

1. Field of the Invention

The present invention relates to a plasma display panel, and more particularly, to a plasma display panel having an improved bright room contrast.

2. Description of the Related Art

A Plasma Display Panel (PDP) is a flat panel display that displays images using a gas discharge phenomenon. PDPs have been highlighted as next generation flat panel displays that can replace Cathode Ray Tubes (CRTs) since they have excellent display capabilities in terms of display capacity, brightness, contrast, afterimage, and viewing angle, and furthermore, are thin and can achieve a large-size display.

In a typical PDP, when discharge occurs in a plurality of discharge cells defined between two substrates, ultraviolet rays are generated and converted to visible light that can be observed by a viewer, thereby achieving images through the emission of the visible light.

When external visible light incident on a transparent front substrate is reflected from a white transparent dielectric layer, white barrier ribs, apparently white phosphors, etc., and pass through the front substrate, reflection brightness is increased, thereby reducing the bright room contrast of a PDP.

In view of the above-described problem, according to a conventional method, black stripes are formed using a dark material with low reflectivity in order to absorb external incident light, thereby reducing reflection brightness. However, in order to separately form the black stripes, additional paste coating and patterning processes are needed. In addition, since the black stripes are only formed in non-display areas in order to prevent the black stripes from blocking the emission of visible light, absorption of external light is only performed over a very limited area of a PDP.

### SUMMARY OF THE INVENTION

An aspect of the present invention is directed toward a plasma display panel having an improved bright room contrast based on a subtractive color mixing principle and a complementary color effect.

An embodiment of the present invention provides a plasma display panel for displaying an image at its front surface by employing gas excitation, the plasma display panel including a plurality of discharge cells for displaying the image, wherein phosphors colored with a first color are coated in the discharge cells, and at least one layer having a second color, wherein the first and second colors are complementary.

Another embodiment of the present invention provides a plasma display panel including: a front substrate having an image display surface; a rear substrate facing the front substrate; barrier ribs defining a plurality of discharge cells between the front substrate and the rear substrate; a plurality of discharge electrodes extending across the discharge cells for inducing discharge; a front dielectric layer on the front substrate, the discharge electrodes being covered by the front dielectric layer; phosphors coated in the discharge cells; and a discharge gas filled in the discharge cells, wherein the front substrate and the phosphors are colored with complementary first and second colors, respectively.

Another embodiment of the invention provides a plasma display panel including: a front substrate having an image display surface; a rear substrate facing the front substrate; barrier ribs defining a plurality of discharge cells between the front substrate and the rear substrate; a plurality of discharge electrodes extending across the discharge cells and inducing discharge; a front dielectric layer on the front substrate and covering the discharge electrodes; phosphors coated in the discharge cells; and a discharge gas filled in the discharge cells, wherein the front substrate, the front dielectric layer, and the phosphors, which are sequentially disposed from front to back, are alternately colored with complementary first and second colors.

Another embodiment of the present invention provides plasma display panel including: a front substrate having an image display surface; a rear substrate facing the front substrate; barrier ribs defining a plurality of discharge cells between the front substrate and the rear substrate; a plurality of discharge electrodes extending across the discharge cells and inducing discharge; a front dielectric layer on the front substrate and covering the discharge electrodes; phosphors coated in the discharge cells; and a discharge gas filled in the discharge cells, wherein the front substrate, the front dielectric layer, and the phosphors, which are sequentially disposed from front to back, are colored with a first color, a second color, and a third color, respectively, forming complementary color relationships.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is an exploded perspective view illustrating a plasma display panel according to a first embodiment of the present invention;

FIG. 2 is a cross-sectional view taken along lines II-II and II′-II′ of FIG. 1;

FIG. 3 is a color circle diagram illustrating subtractive color mixing of different colors and complementary color relationships;

FIG. 4 is a modified embodiment of the plasma display panel illustrated in FIG. 2;

FIG. 5 is a cross-sectional view illustrating a plasma display panel according to a second embodiment of the present invention;

FIG. 6 is a modified embodiment of the plasma display panel illustrated in FIG. 5;

FIG. 7 is a cross-sectional view illustrating a plasma display panel according to a third embodiment of the present invention;

FIG. 8 is a modified embodiment of the plasma display panel illustrated in FIG. 7;

FIG. 9 is a cross-sectional view illustrating a plasma display panel according to a fourth embodiment of the present invention;

FIG. 10 is a modified embodiment of the plasma display panel illustrated in FIG. 9;

FIG. 11 is a cross-sectional view illustrating a plasma display panel according to a fifth embodiment of the present invention;

FIG. 12 is a color mixing diagram illustrating the complementary color relationships of three colors; and

FIG. 13 is a modified embodiment of the plasma display panel illustrated in FIG. 11.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

### First Embodiment

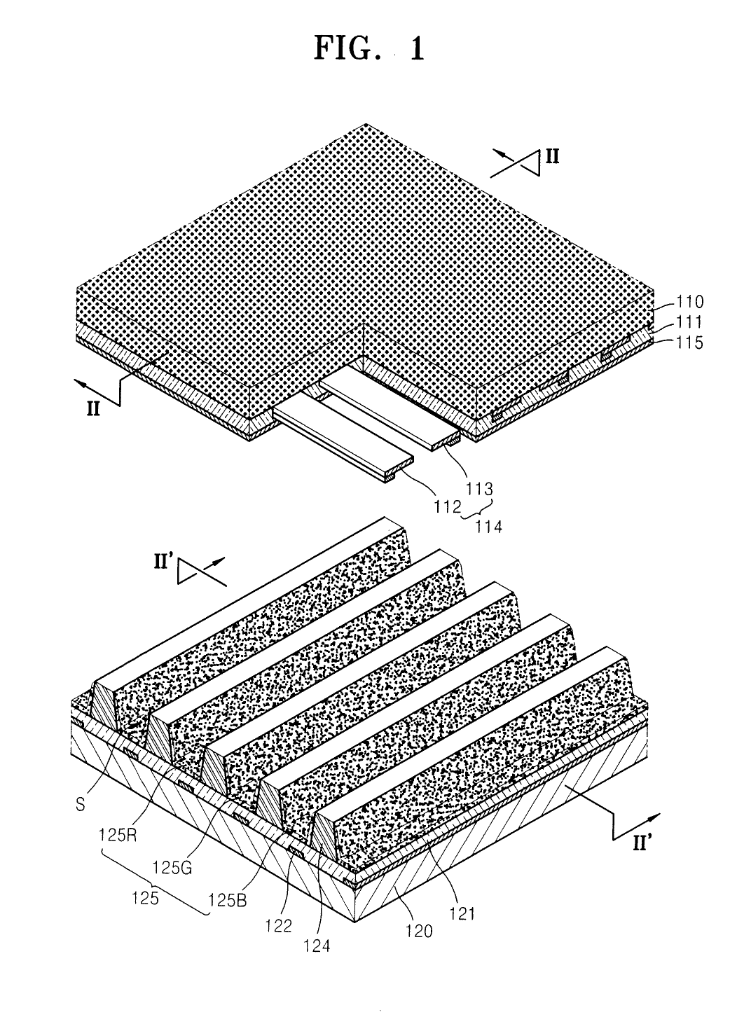

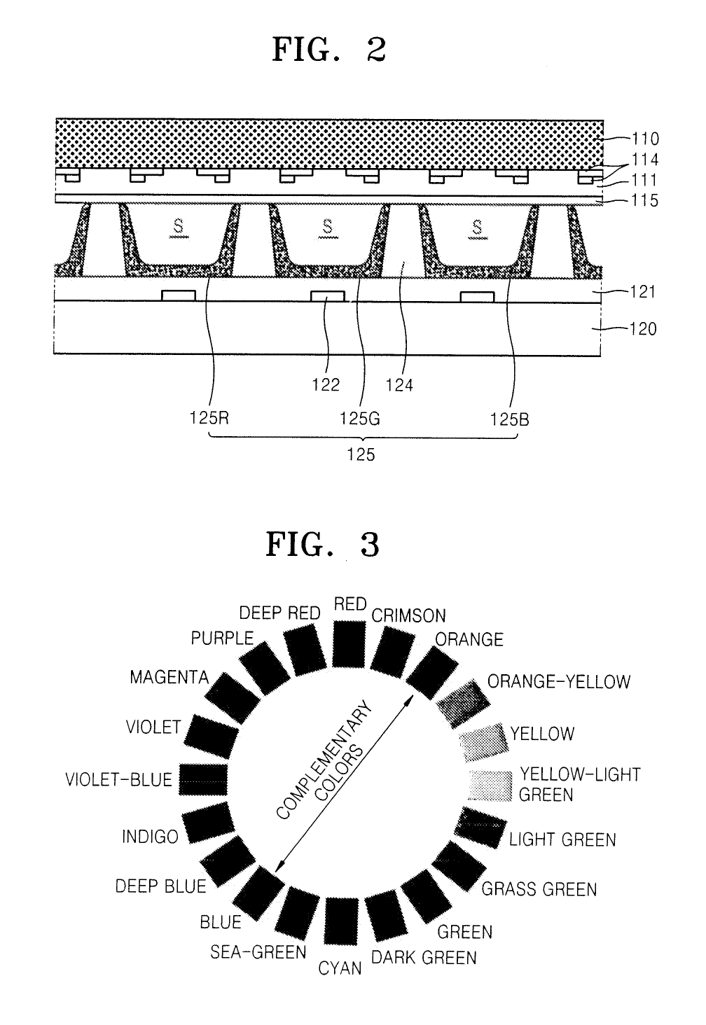

FIG. 1 is an exploded perspective view illustrating a plasma display panel according to a first embodiment of the present invention and FIG. 2 is a cross-sectional view taken along lines II-II and II′-II′ of FIG. 1. Referring to FIGS. 1 and 2, a Plasma Display Panel (PDP) includes a front substrate 110 and a rear substrate 120 that are disposed to face each other and are separated from each other by a distance (e.g. a predetermined distance), and barrier ribs 124 disposed between the front substrate 110 and the rear substrate 120 to define a plurality of discharge cells S. The front substrate 110 and the rear substrate 120 may be glass substrates made of a glass material. The barrier ribs 124 define the plurality of the discharge cells S as independent emission areas. FIGS. 1 and 2 illustrate that the barrier ribs 124 are arranged in open-type stripe patterns that extend in one direction to be parallel to each other. However, the barrier ribs 124 may also be arranged in closed-type matrix patterns.

A plurality of discharge electrode pairs 114 are disposed between the front substrate 110 and the rear substrate 120. The discharge electrode pairs 114 may be arranged parallel to each other to extend across the discharge cells S, and may be supported on the front substrate 110. Each of the discharge electrode pairs 114 may include a transparent electrode 112 and a bus electrode 113 that are disposed to face each other. Meanwhile, a plurality of address electrodes 122 may be disposed on the rear substrate 120 in such a manner that the address electrodes 122 cross the discharge electrode pairs 114. The discharge electrode pairs 114 and the address electrodes 122 may be respectively buried in (i.e. covered by) front and rear dielectric layers 111 and 121, respectively, on the front substrate 110 and the rear substrate 120, respectively. The front and rear dielectric layers 111 and 121 protect the discharge electrode pairs 114 and the address electrodes 122 from ionic impact during discharge, and provide an environment advantageous for discharge. A protective layer 115 made of mainly MgO may be further disposed on a lower surface of the front dielectric layer 111 covering the discharge electrode pairs 114.

Phosphors 125 are distributed in areas defined by the barrier ribs 124. The phosphors 125 convert ultraviolet (UV) rays generated by discharge into respective monochromatic lights. For example, red, green, and blue phosphors 125R, 125G, and 125B may be coated in an array (e.g., a predetermined array). Each of the discharge cells S has a light color corresponding to a coated phosphor. The discharge cells S are filled with a discharge gas that can be excited by discharge to generate UV rays.

The front substrate 110 is colored with a first color, and the phosphors 125 are colored with a second color different from the first color. Subtractive color mixing occurs in overlapping regions of the front substrate 110 and the phosphors 125 that are respectively colored with different colors, thereby reducing both brightness and saturation. As a result, the overlapping regions appear dark. The term “subtractive color mixing” refers to a characteristic that, as different colors are mixed, the resulting color is darker. FIG. 3 illustrates a color circle. Referring to FIG. 3, mixing colors at neighboring positions produces an intermediate color, and mixing colors which are located far from each other produces a near-gray color. Mixing complementary colors, which are located at opposite positions (or across the circle from each other) produces a black color or a near-black color. As illustrated in the color circle of FIG. 3, there are many complementary color pairs, e.g., red-cyan, yellow-indigo, and blue-orange.

For example, the first color of the front substrate 1 10 and the second color of the phosphors 125 may be mutually exclusively selected from complementary blue and orange colors respectively. When the front substrate 110 and the phosphors 125 that are complementarily colored are externally viewed, overlapping regions of the front substrate 110 and the phosphors 125 appear dark black or near-black due to the subtractive color mixing of complementary colors. As a result, external light incident on a PDP is absorbed in the black regions, thereby reducing the reflection of external light and enhancing the contrast characteristics of an image. The front substrate 110 and the phosphors 125 may include coloring materials corresponding to selected colors, e.g., a blue-coloring material (e.g., Mn, Ni, or Co) and an orange-coloring material (e.g., Cu, Sb, or Cr).

When compared to a conventional colorless transparent glass substrate, a colored front substrate may cause some loss in terms of emission brightness due to blockage or selective transmission of some of the visible light generated inside a panel, or the like. However, a conventional PDP cannot prevent external light reflection lowering image quality since external light entering into the panel via a transparent front substrate and a transparent front dielectric layer can be reflected from phosphors which appear white due to the intrinsic color of the phosphor material. In the present invention, the reflection of external light is significantly reduced through mixing of complementary colors. Thus, a reduction in emission brightness by a colored front substrate can be sufficiently compensated, thereby significantly improving a bright room contrast, which is used as an indicator of image quality.

Full-color images may be created through the combination of different monochromatic lights. The monochromatic light contributes to a total brightness according to wavelength ranges. Also, color images may be created through combinations of the three primary colors of light, i.e., red, green, and blue. It is known that about 50% of the total brightness is achieved by green light, and thus, green light has the most significant effect on the total brightness. Thus, when emission efficiency is reduced by addition of a coloring material to a green phosphor, a reduction in brightness over the entire display may occur. In this regard, coloration may be selectively performed according to the type of phosphors, instead of coloring all phosphors. For example, in order to maintain brightness, green phosphors may not be colored, whereas red and/or blue phosphors may be colored. In another example, taking into consideration that phosphors have different emission efficiencies, no coloring material may be added to blue phosphors with the lowest emission efficiency, whereas red and/or green phosphors may be colored, thereby achieving an entire balance in color tone.

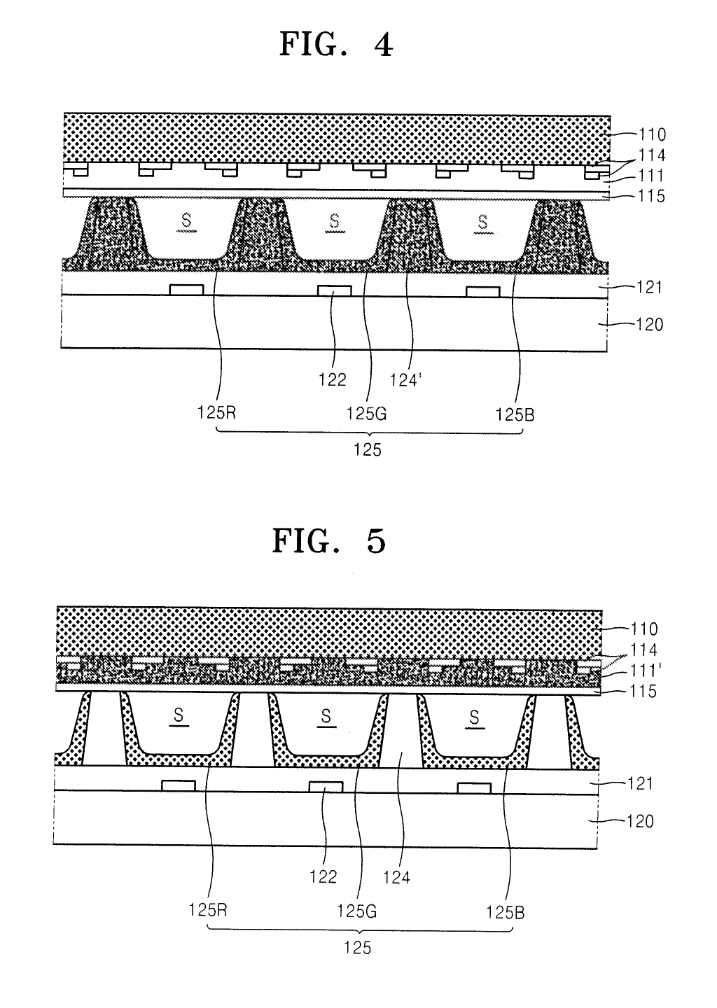

FIG. 4 is a cross-sectional view illustrating a PDP according to a modified embodiment of the embodiment of FIG. 2. Here, barrier ribs 124′, together with phosphors 125, are colored with a second color. When the front substrate 110 is colored with the first color, and the barrier ribs 124′, which are at non-display areas, and the phosphors 125, are colored with the second color complementary to the first color, the absorption of external light based on a complementary color effect can be substantially achieved over an entire display surface. The barrier ribs 124′ may be formed by coating a barrier rib paste containing a coloring material on regions (e.g. predetermined regions). For example, a blue-coloring material such as Mn, Ni, or Co, or an orange-coloring material such as Cu, Sb, or Cr may be added to a common barrier rib paste to form blue- or orange-colored barrier ribs.

In this embodiment, the barrier ribs 124′ may exhibit a color (e.g. a predetermined color) when viewed from the front substrate 110 displaying images. Thus, although the barrier ribs 124′ may be wholly colored, only top parts of the barrier ribs 124′ close to the front substrate 110 may be selectively colored in one embodiment of the present invention.

### Second Embodiment

FIG. 5 illustrates a PDP according to a second embodiment of the present invention. Here, a front substrate 110 and phosphors 125 are colored with colors (e.g. predetermined colors), like in the previous embodiments. However, the second embodiment of the present invention is different from the previous embodiments in that a front dielectric layer 111′ is also colored with a color (e.g. a predetermined color). In order to alternately distribute complementary first and second colors, the front substrate 110 is colored with a first color, the front dielectric layer 111′ is colored with a second color, and the phosphors 125 are colored with the first color.

Therefore, a combination of the first color of the front substrate 110 and the second color of the front dielectric layer 111′ produces a complementary color effect, and furthermore, a combination of the second color of the front dielectric layer 111′ and the first color of the phosphors 125 produces another complementary color effect to thereby achieve a double-complementary color effect. That is, when the complementary first and second colors are alternately stacked, darker black areas are observed from a display surface of the PDP, thereby increasing an external light absorption effect. The effectiveness of such a double-complementary color effect can be demonstrated by comparing a double-complementary color structure according to the second embodiment of the present invention with a single-complementary color structure, as illustrated in FIG. 2, in terms of external light reflection brightness and bright room contrast. For example, the external light reflection brightness of the double-complementary color structure may be about 8.2 cd/m2, which is improved compared to an external light reflection brightness (about 10.2 cd/m2) of the single-complementary color structure. The external light reflection brightness affects a bright room contrast ratio, which is an indicator of image quality, and the bright room contrast ratio can be defined as follows.

$$Bright room contrast ratio = \frac{peak brightness + background brightness}{external light reflection brightness + background brightness}$$

where the peak brightness is a brightness of the highest light output level that can be achieved in a panel, i.e., brightness achieved when the gray level of 256 is displayed on all pixels, and the background brightness is brightness of the lowest light output level that can be achieved in a panel, i.e., brightness achieved when the gray level is 0. When measured under the same conditions, the bright room contrast ratio of the single-complementary color structure is about 93:1, and the bright room contrast ratio of the double-complementary color structure, according to the second embodiment of the present invention, is about 120:1. Therefore, the double-complementary color effect can significantly improve a bright room contrast ratio.

As described above, the first color and the second color can be selected from many complementary color pairs. For example, the first color and the second color may be selected from blue and orange colors, respectively. In this case, the front substrate 111 directly exposed to external light may be colored with a blue color having a relatively low brightness.

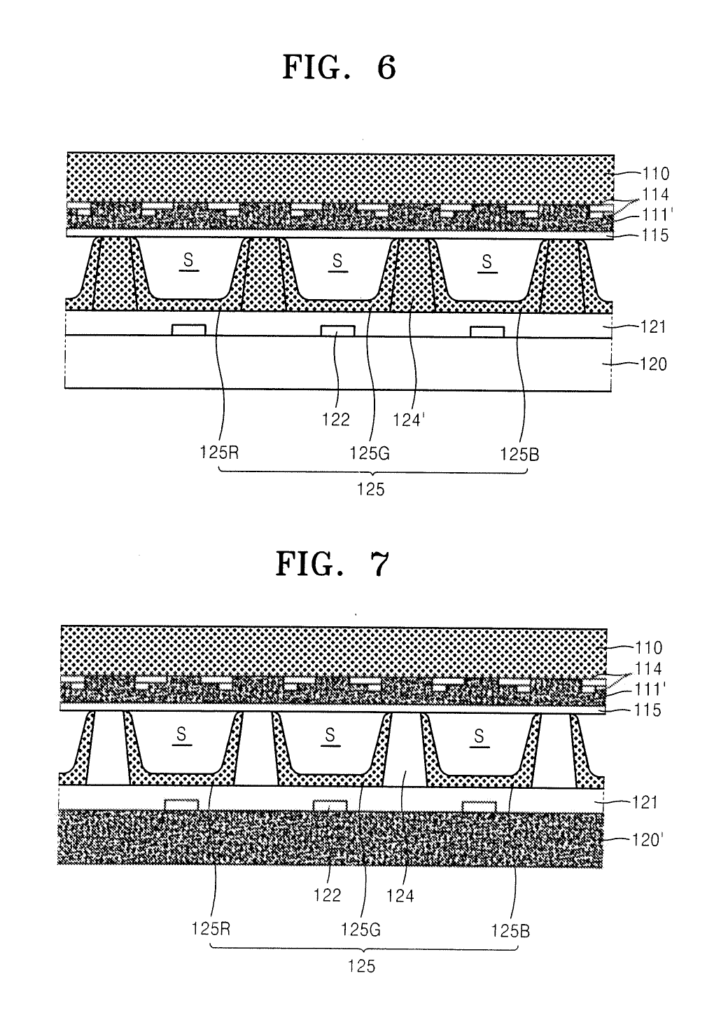

FIG. 6 is a cross-sectional view illustrating a PDP according to a modified embodiment of the embodiment of FIG. 5. Referring to FIG. 6, barrier ribs 124′ partitioning phosphors 125 are colored with the same color as the phosphors 125. Thus, in this embodiment of the present invention, a double-complementary color effect can be extended beyond emission areas, wherein the phosphors 125 are arranged, to non-display areas, wherein the barrier ribs 124′ are arranged.

### Third Embodiment

FIG. 7 is a cross-sectional view illustrating a PDP according to a third embodiment of the present invention. Referring to FIG. 7, a front substrate 110, a front dielectric layer 111′, phosphors 125, and a rear substrate 120′ are colored with colors (e.g. predetermined colors). By alternately stacking complementary first and second colors, a multiple-complementary color effect can be achieved. In more detail, the front substrate 110 is colored with a first color, the front dielectric layer 111′ is colored with a second color, the phosphors 125 are colored with the first color, and the rear substrate 120′ is colored with the second color. Here, a color combination of the front substrate 110 and the front dielectric layer 111′ provides a complementary color effect, a color combination of the front dielectric layer 111′ and the phosphors 125 provides another complementary color effect, and a color combination of the phosphors 125 and the rear substrate 120′ provides a further complementary color effect.

As such, in the third embodiment of the present invention, an image display surface appears darker black through a triple-complementary color effect, thereby facilitating the absorption of external light and resulting in clearer images. Effectiveness of the triple-complementary color effect can be demonstrated by comparing external light reflection brightness and a bright room contrast ratio. External light reflection brightness gradually decreases from a single-complementary color structure (about 10.2 cd/m2), to a double-complementary color structure (about 8.2 cd/m2), and to a triple-complementary color structure (about 6.6 cd/m2). When measured under the same conditions, the bright room contrast ratio of a single-complementary color structure is about 93:1, the bright room contrast ratio of a double-complementary color structure is about 120:1, and the bright room contrast ratio of a triple-complementary color structure, according to the second embodiment of the present invention, is about 151:1. Here, a multiple-complementary color effect can significantly improve a bright room contrast ratio. When comparing a conventional structure having no complementary color effect with a structure according to the second embodiment of the present invention, the external light reflection brightness of the structure of the second embodiment of the present invention may be about 6.6 cd/m2, which is significantly improved compared to the external light reflection brightness (about 15.2 cd/m2) of the conventional structure. Thus, the bright room contrast ratio of the structure of the second embodiment of the present invention is about 151:1, which is significantly improved compared to the bright room contrast ratio (about 70:1) of the conventional structure.

The colored phosphors 125 can display colors (e.g. predetermined colors) on an image display surface via the transparent front substrate 110 and the front dielectric layer 111′. Thus, color mixing occurring among the front substrate 110, the front dielectric layer 111′, and the phosphors 125 is not affected. However, in order to allow the color of the colored rear substrate 120′ to be apparent (or have external light be incident on the colored rear substrate 120′) through the relatively opaque phosphors 125 and to combine the color with other colors on the image display surface, it may be necessary to change the thickness of the phosphors 125 according to the position of the rear substrate 120′. For example, portions of the phosphors 125 supported on a rear dielectric layer 121 may be adjusted to be thinner than portions of the phosphors 125 supported on barrier ribs 124. For reference, the rear dielectric layer 121 may generally be transparent, and thus, does not block the color of the colored rear substrate 120′.

The first color and the second color can be selected from many complementary color pairs. For example, blue and orange colors may be used. Substantial coloration for constitutional elements can be appropriately (or suitably) performed, taking into consideration that the color of the front substrate 110 that is exposed to the outside is visible on an image display surface and the emission efficiency of the phosphors 125 may be changed (or optimized) according to the type of coloring material.

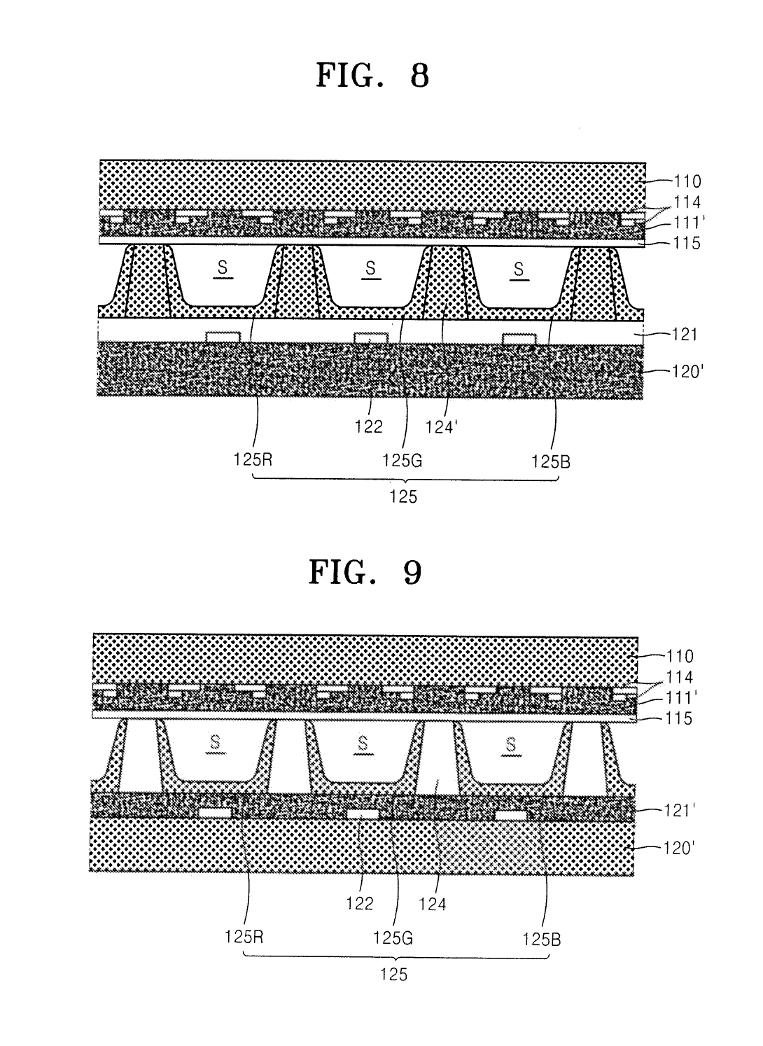

FIG. 8 is a cross-sectional view illustrating a PDP according to a modified embodiment of the embodiment of FIG. 7. Referring to FIG. 8, barrier ribs 124′ partitioning phosphors 125 are colored with the same color as the phosphors 125. The entire image display surface, including both emission areas and non-emission areas, appears black due to the colored phosphors 125 and the barrier ribs 124′, thereby achieving clearer images.

### Fourth Embodiment

FIG. 9 is a cross-sectional view illustrating a PDP according to a fourth embodiment of the present invention. Referring to FIG. 9, a front substrate 110, a front dielectric layer 111′, phosphors 125, a rear dielectric layer 121′, and a rear substrate 120′ are colored with colors (e.g. predetermined colors). By alternately stacking complementary first and second colors, a multiple-complementary color effect can be achieved. In more detail, the front substrate 110 is colored with a first color, the front dielectric layer 111′ is colored with a second color, the phosphors 125 are colored with the first color, the rear dielectric layer 121′ is colored with the second color, and the rear substrate 120′ is colored with the first color. Through mixing of complementary colors of elements disposed on top of one another, an image display surface appears darker black, which is more advantageous in terms of absorption of external light, thereby achieving clearer images. The effectiveness of the above quadruple-complementary color effect can be demonstrated by comparing external light reflection brightness and a bright room contrast ratio. External light reflection brightness gradually decreases from a single-complementary color structure (about 10.2 cd/m2), to a double-complementary color structure (about 8.2 cd/m2), to a triple-complementary color structure (about 6.6 cd/m2), and to a quadruple-complementary color structure (about 5.8 cd/m2). Moreover, as measured under the same conditions, the bright room contrast ratio of a single-complementary color structure is about 93:1, the bright room contrast ratio of a double-complementary color structure is about 120:1, the bright room contrast ratio of a triple-complementary color structure is about 151:1, and the bright room contrast ratio of a quadruple-complementary color structure according to the current embodiment of the present invention is about 172:1. This shows that a multiple complementary color principle can significantly improve a bright room contrast ratio. When comparing a conventional structure having no complementary color effect with a structure according to the fourth embodiment of the present invention, the external light reflection brightness of the structure of the fourth embodiment of the present invention is about 5.8 cd/m2, which is significantly improved compared to the external light reflection brightness (about 15.2 cd/m2) of the conventional structure. Thus, the bright room contrast ratio of the structure of the fourth embodiment of the present invention is about 172:1, which is significantly improved compared to the bright room contrast ratio (about 70:1) of the conventional structure.

Similarly as described above, in order to allow the colors of the rear dielectric layer 121′ and the rear substrate 120′ to be apparent (or have external light be incident on the colored rear substrate 120′ and rear dielectric layer 121′) through the opaque phosphors 125 and to combine the colors with other colors on an image display surface, it may be necessary to adjust the position or relative thickness of the phosphors 125. Further, the first color and the second color can be selected from various complementary color pairs. For example, blue and orange colors may be used. For example, the colors may be arranged in the order of blue, orange, blue, orange, and blue from top to bottom, or alternatively, in the order of orange, blue, orange, blue, and orange from top to bottom.

FIG. 10 is a cross-sectional view illustrating a PDP according to a modified embodiment of the embodiment of FIG. 9. In a structure in which complementary first and second colors are alternated, if barrier ribs are left as their intrinsic material color, i.e., white, an external light absorption effect through mixing of complementary colors can be reduced. Thus, as illustrated in FIG. 10, barrier ribs 124′ may be colored with the same color as phosphors 125. Therefore, a multiple-complementary color effect of the barrier ribs 124′ with a front substrate 110 and a front dielectric layer 111′ is achieved in non-emission areas corresponding to the barrier ribs 124′.

### Fifth Embodiment

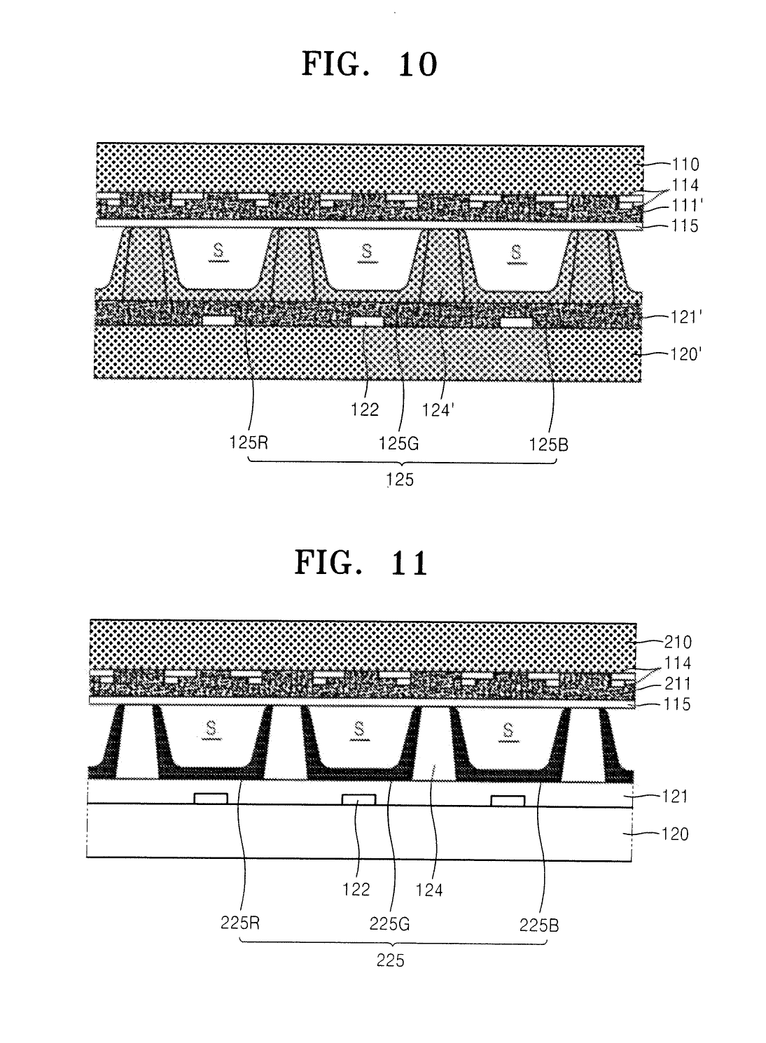

FIG. 11 is a cross-sectional view illustrating a PDP according to a fifth embodiment of the present invention. Referring to FIG. 11, like in the previous embodiments, a PDP includes discharge cells S defined by barrier ribs 124 between a front substrate 210 and a rear substrate 120 that are disposed to face each other. Discharge electrodes 114 are arranged parallel to each other to extend across the discharge cells S, and areas defined by the barrier ribs 124 are coated with phosphors 225. The discharge electrodes 114 and address electrodes 122 are covered with a front dielectric layer 211 and a rear dielectric layer 121, respectively. The front dielectric layer 211 in one embodiment is covered with a protective layer 115 made of MgO.

The front substrate 210 is colored with a first color, the front dielectric layer 211 is colored with a second color, and the phosphors 225 are colored with a third color. By overlapping different colors of elements disposed on top of one another, dark regions where external light is absorbed are provided. This can be explained by subtractive color mixing that as different colors are mixed, the brightness and saturation of the resulting color are gradually lowered.

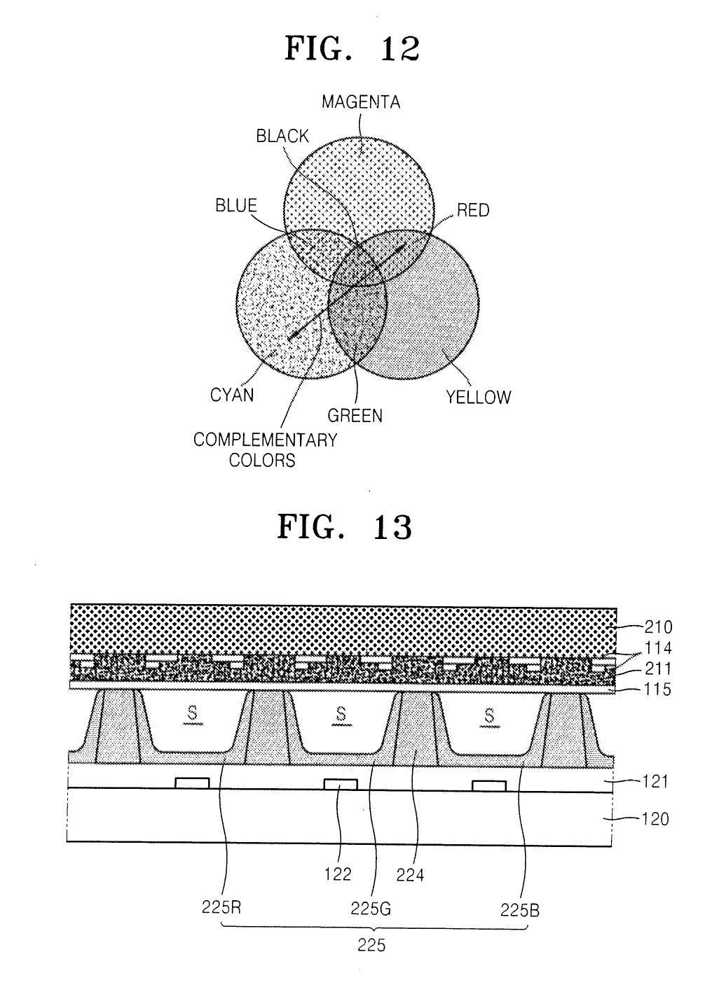

FIG. 12 is a diagram illustrating subtractive color mixing of three primary colors of paints. Referring to FIG. 12, when three primary colors of paints, i.e., magenta, yellow, and cyan are mixed, subtractive color mixing of complementary colors occur, thereby producing black. Mixing any two of magenta, yellow, and cyan produces a color complementary to the other color. For example, mixing magenta with yellow produces red that is the complement of cyan. Similarly, mixing yellow with cyan produces green that is the complement of magenta, and mixing magenta with cyan produces blue that is the complement of yellow.

In this regard, referring again to FIG. 11, when the first through third colors are distributed in a vertical direction and are selected from the above-described three primary colors, overlapping regions of the three primary colors in the PDP appear black, which is advantageous for absorption of external light. Effects of such a subtractive color mixing can be demonstrated by comparing a PDP according to the fifth embodiment of the present invention with a conventional colorless PDP in terms of external light reflection brightness and a bright room contrast ratio. As measured under the same conditions, the external light reflection brightness of the PDP according to the fifth embodiment of the present invention is about 10.2 cd/m2 due to subtractive color mixing, which is lower than the external light reflection brightness (about 15.2 cd/m2) of the conventional PDP. As measured under the same conditions, the bright room contrast ratio of the conventional PDP is about 70:1, whereas the bright room contrast ratio of the PDP according to the current embodiment of the present invention is about 93:1. This shows that image quality is significantly improved through subtractive color mixing.

Various selections can be made in applying the three primary colors to constitutional elements. For example, the front substrate 210 may be colored with magenta, the front dielectric layer 211 may be colored with yellow, and the phosphors 225 may be colored with cyan. Alternatively, the front substrate 210, the front dielectric layer 211, and the phosphors 225 may be colored with cyan, yellow, and magenta, respectively. The front substrate 210, directly exposed to external light, may be colored with a darker color. In order to provide a desired color to the entire panel according to an individual preference or to add a color correction function, the front substrate 210 may be colored with a color (e.g. a predetermined color) selected from the three primary colors.

As described above, in order to achieve full-color images, the phosphors 225 may be arranged to include red phosphors 225R, green phosphors 225G, and blue phosphors 225B, which provide different monochromatic light. Considering a brightness reduction due to coloration, the emission efficiency of the phosphors 225, etc., only predetermined phosphors may be selectively colored.

In the fifth embodiment of the present invention, since the phosphors 225 are disposed only in emission areas, subtractive color mixing of the three primary colors may not be expected in non-emission areas corresponding to the barrier ribs 124. In particular, if the barrier ribs 124 appear white, which is the intrinsic color of a barrier rib material, the absorption of external light is much less effective. Thus, as illustrated in FIG. 13, barrier ribs 224 may be colored with the same color as phosphors 225. Here, since a visual effect sensed in front of a PDP is important, although the barrier ribs 224 may be wholly colored, in an embodiment of the present invention, only parts (top parts in FIG. 13) of the barrier ribs 224 may be selectively colored. As such, since the colored barrier ribs 224 and the colored phosphors 225 are disposed in complementary regions, the absorption of external light through mixing of the three primary colors can be substantially expected over an entire display surface, including emission areas corresponding to the phosphors 225 and non-emission areas corresponding to the barrier ribs 224.

The three primary colors of paints, i.e., magenta, yellow, and cyan, have been exemplified for the above first through third colors. However, provided that mixing two of three selected colors produces a color complementary to the other color, the above-described subtractive color mixing of complementary colors can be applied. Thus, the first through third colors are not limited to predetermined colors, but should be understood in a broad sense.

In the present invention, complementary colors are colored in overlapping regions inside a display, and thus, an image display surface wholly appears black through subtractive color mixing. Therefore, it is not necessary to form common black stripes used for absorbing external light, thereby reducing manufacturing costs and the number of manufacturing processes, resulting in an increase in production yield. Moreover, unlike a conventional PDP in which absorption of external light occurs only in non-display areas corresponding to black stripes, in the present invention, the absorption of external light can be substantially achieved over an entire image display surface, including both display and non-display areas.

In particular, according to an exemplary embodiment of the present invention, a display can be designed to have a combination of complementary colors repeatedly stacked therein for external light absorption when needed, thereby significantly enhancing image vividness according to a required specification.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A plasma display panel for displaying an image by employing gas excitation, the plasma display panel comprising a plurality of discharge cells for displaying the image, wherein phosphors colored with a first color are coated in the discharge cells, and at least one layer having a second color, wherein the first and second colors are complementary.

2. The plasma display panel of claim 1, wherein the first color and the second color are mutually exclusively selected from a blue color and an orange color.

3. The plasma display panel of claim 1, wherein said at least one layer having the second color comprises a front substrate, the plasma display panel further comprising:
a rear substrate facing the front substrate;
barrier ribs defining the plurality of discharge cells between the front substrate and the rear substrate;
a plurality of discharge electrodes extending across the discharge cells and inducing discharge; and
a discharge gas filled in the discharge cells.

4. The plasma display panel of claim 3, wherein the barrier ribs have the first color.

5. The plasma display panel of claim 1, wherein the at least one layer having the second color comprises a front dielectric layer, the plasma display panel further comprising:
a front substrate and a rear substrate that face each other, wherein the front substrate has the first color;
barrier ribs defining the plurality of discharge cells between the front substrate and the rear substrate;
a plurality of discharge electrodes extending across the discharge cells for inducing discharge, the discharge electrodes being covered by the front dielectric layer on the front substrate; and
a discharge gas filled in the discharge cells.

6. The plasma display panel of claim 5, wherein the rear substrate further has the second color.

7. The plasma display panel of claim 5, wherein the barrier ribs have the first color.

8. The plasma display panel of claim 1, wherein the at least one layer having the second color comprises a front dielectric layer, the plasma display panel further comprising:
a front substrate and a rear substrate that face each other and have the first color;
barrier ribs defining the plurality of discharge cells between the front substrate and the rear substrate;
a plurality of discharge electrodes extending across the discharge cells for inducing discharge, the discharge electrodes being covered by the front dielectric layer on the front substrate;
a plurality of address electrodes extending to cross the discharge electrodes;
a rear dielectric layer on the rear substrate and covering the address electrodes, wherein the rear dielectric layer has the second color; and
a discharge gas filled in the discharge cells.

9. The plasma display panel of claim 8, wherein the barrier ribs have the first color.

10. A plasma display panel comprising:
a front substrate having an image display surface;
a rear substrate facing the front substrate;
barrier ribs defining a plurality of discharge cells between the front substrate and the rear substrate;
a plurality of discharge electrodes extending across the discharge cells for inducing discharge;
a front dielectric layer on the front substrate, the discharge electrodes being covered by the front dielectric layer;
phosphors coated in the discharge cells; and
a discharge gas filled in the discharge cells,
wherein the front substrate and the phosphors are colored with complementary first and second colors, respectively.

11. The plasma display panel of claim 10, wherein the first color and the second color are mutually exclusively selected from a blue color and an orange color.

12. A plasma display panel comprising:
a front substrate having an image display surface;
a rear substrate facing the front substrate;
barrier ribs defining a plurality of discharge cells between the front substrate and the rear substrate;
a plurality of discharge electrodes extending across the discharge cells and inducing discharge;
a front dielectric layer on the front substrate and covering the discharge electrodes;
phosphors coated in the discharge cells; and
a discharge gas filled in the discharge cells,
wherein the front substrate, the front dielectric layer, and the phosphors, which are sequentially disposed from front to back, are alternately colored with complementary first and second colors.

13. The plasma display panel of claim 12, wherein the first color and the second color are mutually exclusively selected from a blue color and an orange color.

14. The plasma display panel of claim 12, wherein first complementary mixing of the first color and the second color occurs in an overlapping region of the front substrate and the front dielectric layer, and second complementary mixing of the first color and the second color occurs in an overlapping region of the front dielectric layer and the phosphors.

15. The plasma display panel of claim 12, wherein the rear substrate is colored with the second color.

16. The plasma display panel of claim 15, wherein first complementary mixing of the first color and the second color occurs in an overlapping region of the front substrate and the front dielectric layer, second complementary mixing of the first color and the second color occurs in an overlapping region of the front dielectric layer and the phosphors, and third complementary mixing of the first color and the second color occurs in an overlapping region of the phosphors and the rear substrate.

17. The plasma display panel of claim 12, further comprising a rear dielectric layer between the barrier ribs and the rear substrate and covering the address electrodes.

18. The plasma display panel of claim 17, wherein the rear dielectric layer and the rear substrate are colored with the second color and the first color, respectively.

19. The plasma display panel of claim 18, wherein first complementary mixing of the first color and the second color occurs in an overlapping region of the front substrate and the front dielectric layer, second complementary mixing of the first color and the second color occurs in an overlapping region of the front dielectric layer and the phosphors, third complementary mixing of the first color and the second color occurs in an overlapping region of the phosphors and the rear dielectric layer, and fourth complementary mixing of the first color and the second color occurs in an overlapping region of the rear dielectric layer and the rear substrate.

20. A plasma display panel comprising:
a front substrate having an image display surface;
a rear substrate facing the front substrate;
barrier ribs defining a plurality of discharge cells between the front substrate and the rear substrate;
a plurality of discharge electrodes extending across the discharge cells and inducing discharge;
a front dielectric layer on the front substrate and covering the discharge electrodes;
phosphors coated in the discharge cells; and
a discharge gas filled in the discharge cells,
wherein the front substrate, the front dielectric layer, and the phosphors, which are sequentially disposed from front to back, are colored with a first color, a second color, and a third color, respectively, forming complementary color relationships.

21. The plasma display panel of claim 20, wherein mixing two colors selected from the first color, the second color, and the third color produces a complement of the other color.

22. The plasma display panel of claim 21, wherein the first color, the second color, and the third color are mutually exclusively selected from the group consisting of magenta, yellow, and cyan.
